(19) United States
(12) Patent Application Publication
(10) Pub. No.: US 2025/0377659 A1
(43) Pub. Date: Dec. 11, 2025

(54) METHOD AND APPARATUS FOR CONTROLLING A VEHICLE

(71) Applicant: GM GLOBAL TECHNOLOGY OPERATIONS LLC, Detroit, MI (US)

(72) Inventors: Jacob A. Bond, Rochester Hills, MI (US); Bo Yu, Novi, MI (US); Josh Remmetter, Farmington Hills, MI (US); Jeremy A. Salinger, Southfield, MI (US); Umer Khalid, Farmington Hills, MI (US)

(73) Assignee: GM GLOBAL TECHNOLOGY OPERATIONS LLC, Detroit, MI (US)

(21) Appl. No.: 18/736,724

(22) Filed: Jun. 7, 2024

(51) Int. Cl. G05D 1/223; B60K 26/02; B60T 7/08; B62D 1/24; G05D 1/224

(52) U.S. Cl. CPC G05D 1/223; B60K 26/02; B60T 7/085; B62D 1/24; G05D 1/2245

(57) ABSTRACT

A method and control system for a vehicle includes a handheld console and a first subsystem controller. The handheld console includes first and second analog sticks, a first controller, and a communication system. The first and second analog sticks are in communication with the first controller. The first controller monitors a first input from the first analog stick, and determines a first steering angle based upon the first input and the first steering calibration map, monitors a second input from the second analog stick, and determines a second steering angle based upon the second input and the second steering calibration map. A final steering angle command is determined based upon the first steering angle and the second steering angle, and is communicated to the first subsystem controller of the vehicle to control the steering system.

### INTRODUCTION

Handheld controllers have been used to operate vehicles in wide-open areas. However, existing designs are not suitable for driving requiring precise steering and speed control as is needed for sloped/banked roads and narrow space.

### SUMMARY

The concepts described herein provide elements related to a method, system and/or apparatus that includes a handheld console for remotely operating a vehicle.

An aspect of the disclosure may include a control system for a vehicle that includes a handheld console, a first controller, and a first subsystem controller. The handheld console includes first and second grip portions, first and second analog sticks, and a communication system. The first and second analog sticks are in communication with the first controller. The first subsystem controller is operatively connected to an on-vehicle steering system. The first controller is arranged to communicate with the first subsystem controller of the vehicle via the communication system. The first controller includes a first control routine, a first steering calibration map, a second steering calibration map, and algorithmic code that is executable to monitor a first input from the first analog stick, and determine a first steering angle based upon the first input and the first steering calibration map, monitor a second input from the second analog stick, and determine a second steering angle based upon the second input and the second steering calibration map. A final steering angle command is determined based upon the first steering angle and the second steering angle, and is communicated, via the communication system, to the first subsystem controller of the vehicle to control, via the first subsystem controller, the steering system.

An aspect of the disclosure may include the first steering calibration map being a first linear relationship between the first input from the first analog stick and the first steering angle; wherein the second steering calibration map comprises a second linear relationship between the second input from the second analog stick and the second steering angle; and wherein the first linear relationship is equivalent to the second linear relationship.

Another aspect of the disclosure may include the first steering calibration map being a first linear relationship between the first input from the first analog stick and the first steering angle; wherein the second steering calibration map comprises a second linear relationship between the second input from the second analog stick and the second steering angle; and wherein the first linear relationship provides a coarse steering angle response, and wherein the second linear relationship provides a fine steering angle response.

Another aspect of the disclosure may include the first steering calibration map being a first non-linear relationship between the first input from the first analog stick and the first steering angle; wherein the second steering calibration map comprises a second non-linear relationship between the second input from the second analog stick and the second steering angle; and wherein the first non-linear relationship is equivalent to the second non-linear relationship.

Another aspect of the disclosure may include the first steering calibration map being a first non-linear relationship between the first input from the first analog stick and the first steering angle; wherein the second steering calibration map comprises a second non-linear relationship between the second input from the second analog stick and the second steering angle; and wherein the first non-linear relationship provides a coarse steering angle response, and wherein the second non-linear relationship provides a fine steering angle response.

Another aspect of the disclosure may include the handheld console including a first selector switch having a first state and a second state; wherein, when the first selector switch is in the first state, the first relationship between the first input from the first analog stick and the first steering angle is equivalent to the second relationship between the second input from the second analog stick and the second steering angle; and wherein, when the first selector switch is in the second state, the first relationship between the first input from the first analog stick and the first steering angle differs from the second relationship between the second input from the second analog stick and the second steering angle.

Another aspect of the disclosure may include a first default input from the first analog stick being a zero steering command, and wherein a second default input from the second analog stick comprises a zero steering command.

Another aspect of the disclosure may include the handheld console including a first analog trigger and a second analog trigger, with the first analog trigger and the second analog trigger being in communication with the first controller. A second subsystem controller is operatively connected to an on-vehicle braking system, and a third subsystem controller operatively connected to an on-vehicle propulsion system. The first controller includes a second control routine, a braking calibration map, and an acceleration calibration map. The second control routine including algorithmic code that is executable to: monitor, via the first analog trigger, a third input; and determine a braking request based upon the third input and the braking calibration map, monitor, via the second analog trigger, a fourth input, and determine an acceleration request based upon the fourth input and the acceleration calibration map, determine a vehicle speed request based upon the braking request and the acceleration request, communicate, via the communication system, the vehicle speed request to the second subsystem controller and the third subsystem controller of the vehicle, and control, via the second and third subsystem controllers, the braking system and the propulsion system in response to the vehicle speed request.

Another aspect of the disclosure may include a second default input from the first analog trigger being a non-zero braking command.

Another aspect of the disclosure may include a third default input from the second analog trigger being a non-zero acceleration command.

Another aspect of the disclosure may include the handheld console including a first switch having a first position and a second position; and a fourth subsystem controller operatively connected to a transmission range selector, the transmission range selector operative to control the vehicle in one of a forward direction or a reverse direction; wherein the fourth subsystem controller is operative to command the transmission range selector to operate the vehicle in the forward direction when the first bi-stable button is in the first position; and wherein the fourth subsystem controller is operative to command the transmission range selector to operate the vehicle in the reverse direction when the first bi-stable button is in the second position.

Another aspect of the disclosure may include the handheld console including a digital display screen arranged to display a representation of the vehicle in situ.

Another aspect of the disclosure may include a virtual reality headset arranged to display a representation of the vehicle in situ.

Another aspect of the disclosure may include a method for controlling a vehicle, including: arranging a handheld console including first and second analog sticks; monitoring, via a controller, a first input from the first analog stick; determining, via a first steering calibration map, a first steering angle based upon the first input; monitoring, via the controller, a second input from the second analog stick; determining, via a second steering calibration map, a second steering angle based upon the second input; determining a final steering angle command based upon the first steering angle and the second steering angle; communicating, via a communication system, the final steering angle command to a first subsystem controller of the vehicle, and controlling, via the first subsystem controller, the steering system in response to the final steering angle command.

Another aspect of the disclosure may include arranging the console including a first analog trigger and a second analog trigger; monitoring, via the first analog trigger, a third input; determining, via a braking calibration map, a braking request based upon the third input; monitoring, via the second analog trigger, a fourth input; determining, via an acceleration calibration map, an acceleration request based upon the fourth input; determining a vehicle speed request based upon the braking request and the acceleration request; communicating, via the communication system, the vehicle speed request to a second subsystem controller and a third subsystem controller of the vehicle, and controlling, via the second and third subsystem controllers, the braking system and the propulsion system in response to the vehicle speed request.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a side view of a vehicle and an embodiment of a handheld console, in accordance with the disclosure.

FIG. 2 schematically shows details related to an embodiment of a handheld console, in accordance with the disclosure.

FIGS. 3A, 3B, 3C, and 3D schematically illustrate embodiments of a steering control routine for controlling vehicle steering employing an embodiment of a handheld console, in accordance with the disclosure.

FIG. 4 schematically illustrates an embodiment of a vehicle longitudinal acceleration control routine for controlling vehicle braking and acceleration employing an embodiment of a handheld console, in accordance with the disclosure.

The appended drawings are not necessarily to scale, and present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

For purposes of convenience and clarity, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

The following detailed description is merely exemplary in nature and is not intended to limit the application and uses. Furthermore, there is no intention to be bound by an expressed or implied theory presented herein. Throughout the drawings, corresponding reference numerals indicate like or corresponding parts and features.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

Embodiments may be described herein in terms of functional and/or logical block components and various processing steps. Such block components may be realized by a combination or collection of mechanical and electrical hardware, software, and/or firmware components configured to perform the specified functions. For example, an embodiment may employ various combinations of mechanical components and electrical components, integrated circuit components, memory elements, digital signal processing elements, logic elements, look-up tables, or the like, which may carry out a variety of functions under the control of one or more microprocessors or other control devices. In addition, those skilled in the art will appreciate that the illustrated embodiments may be practiced in conjunction with mechanical and/or electronic systems, and that the vehicle systems described herein are merely illustrative embodiments of possible implementations.

For the sake of brevity, conventional components and techniques and other functional aspects of the systems (and the individual operating components of the systems) may not be described in detail herein. Furthermore, the connecting lines shown in the various figures contained herein are intended to represent example functional relationships and/or physical couplings between the various elements. Many alternative or additional functional relationships or physical connections may be present in an embodiment of the disclosure.

Furthermore, the first definition of an acronym or other abbreviation applies to subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this disclosure is not limited to the specific embodiments and methods described below, as specific components and/or conditions may, of course, vary. Furthermore, the terminology used herein is used for the purpose of describing particular embodiments of the present disclosure and is not intended to be limiting.

Also, as used in the specification and the appended claims, the singular form “a,” “an,” and “the” comprise plural referents unless the context clearly indicates otherwise. For example, reference to a component in the singular is intended to comprise a plurality of components.

The use of ordinals such as first, second and third does not necessarily imply a ranked sense of order, but rather may distinguish between multiple instances of an act or structure.

Numerical values of parameters (e.g., of quantities or conditions) in this specification, including the appended claims, are to be understood as being modified by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

As employed herein, terms such as “vertical”, “horizontal”, “left”, “right”, “upper”, “lower”, and similar expressions are non-limiting terms that merely describe the various elements as illustrated in the Figures, and are not intended to limit the scope of the disclosure.

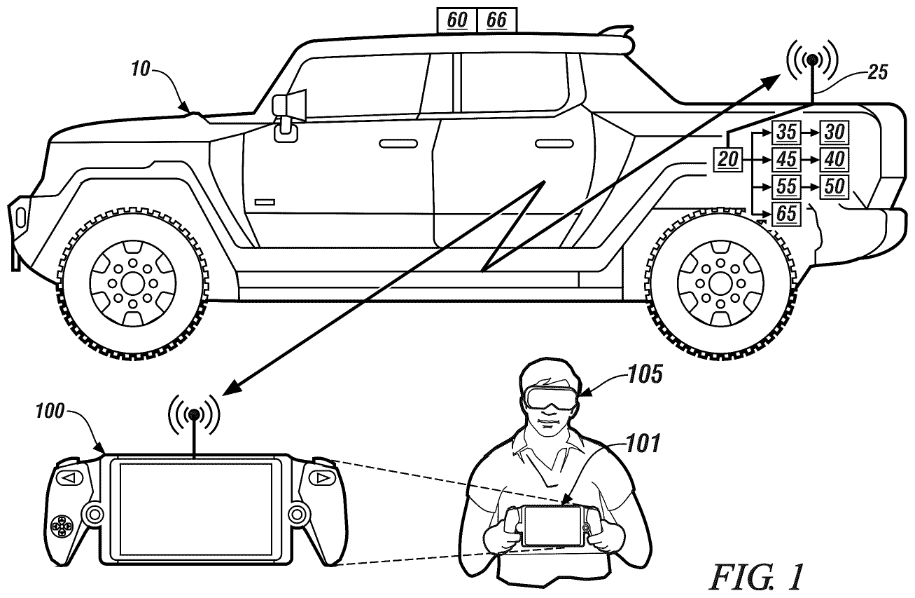

Referring now to the drawings, wherein the showings are for the purpose of illustrating certain exemplary embodiments and not for the purpose of limiting the same, FIG. 1 schematically shows an embodiment of a vehicle 10 having one or more subsystems that are controllable via a handheld console 100, including the vehicle 10 being remotely controllable via the console 100.

An operator 101 may employ the console 100 to remotely control operation of the vehicle 10. In one embodiment, the operator 101 may be further equipped with a virtual reality (VR) headset 105, which is able to display images that are generated by an on-vehicle spatial monitoring subsystem 60, to assist in the remotely controlled operation of the vehicle 10. The console 100 includes, in one embodiment, a display screen 110 that may be arranged to display a representation of the vehicle 10 in situ. The VR headset 105 may be arranged to display a representation of the vehicle 10 in situ.

The vehicle 10 may include, but not be limited to a mobile platform in the form of a commercial vehicle, industrial vehicle, recreational vehicle, agricultural vehicle, passenger vehicle, aircraft, watercraft, train, all-terrain vehicle, personal movement apparatus, robot and the like to accomplish the purposes of this disclosure.

In one embodiment and as described herein, the vehicle 10 includes a vehicle controller 20 having wireless communication technology 25, a steering subsystem 30 and associated steering controller 35, a wheel braking subsystem 40 and associated braking controller 45, a propulsion subsystem 50 and associated propulsion controller 55, the spatial monitoring subsystem 60, and a navigation subsystem 65 including a Global Position System (GPS) sensor.

The steering subsystem 30 includes an electric power steering device or a steer-by-wire device, and associated sensors that are employed by the steering controller 35 to determine an operator directional request and convert it to a steering angle for steerable wheels of the vehicle 10. The steering angle may be in the form of a road wheel angle, a steering rack position, or another parameter.

The wheel braking subsystem 40 includes a device capable of applying braking torque to one or more vehicle wheels and associated sensors that are employed by the braking controller 45 to monitor signals from the sensors and generate commands to one or more actuators to control operation in a manner that is responsive to an operator request for braking.

The propulsion subsystem 50 includes a prime mover, such as an internal combustion engine, an electric machine, a combination thereof, or another device. In one embodiment, the prime mover is coupled to a fixed gear or continuously variable transmission that is capable of transferring torque and reducing speed. The propulsion subsystem 50 may also include a driveline, such as a differential, transaxle or another gear reduction mechanism. Operation of elements of the propulsion subsystem 50 may be controlled by the propulsion controller 55, which may include one or a plurality of subcontrollers that monitor signals from one or more sensors and generate commands to one or more actuators to control operation in a manner that is responsive to an operator request for vehicle acceleration and propulsion.

The spatial monitoring subsystem 60 includes a spatial monitoring controller in communication with one or a plurality of object-locating sensors. The vehicle spatial monitoring subsystem 60 dynamically monitors an area proximate to the vehicle 10 and generates digital representations of observed or otherwise discerned remote objects. The spatial monitoring subsystem 60 may determine a linear range, relative speed, and trajectory of each proximate remote object based upon information from one or a plurality of the object-locating sensors, including employing sensor data fusion. The object-locating sensors may be disposed as front corner sensors, rear corner sensors, rear side sensors, side sensors, a front radar sensor, and a camera in one embodiment, although the disclosure is not so limited. Placement of the object-locating sensors permits the spatial monitoring subsystem 60 to monitor traffic flow including proximate vehicles and other objects around the vehicle 10. The object-locating sensors may include, by way of non-limiting examples, range sensors, such as FM-CW (Frequency Modulated Continuous Wave) radars, pulse and FSK (Frequency Shift Keying) radars, and LIDAR (Light Detection and Ranging) devices, and ultrasonic devices which rely upon effects such as Doppler-effect measurements to locate forward objects. The object-locating sensors 66 may also include charged-coupled devices (CCD) or complementary metal oxide semi-conductor (CMOS) video image sensors, and other camera/video image processors which utilize digital photographic methods to ‘view’ forward and/or rear objects including one or more object vehicle(s). Other sensor technologies may be employed in place of or in conjunction with the aforementioned sensors.

The terms controller, control module, module, control, control unit, processor and similar terms refer to various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions, including monitoring inputs from sensing devices and other networked controllers and executing control and diagnostic routines to control operation of actuators. Routines may be periodically executed at regular intervals, or may be executed in response to occurrence of a triggering event. Communication between controllers, and communication between controllers, actuators and/or sensors may be accomplished using a direct wired link, a networked communications bus link, a wireless link, a serial peripheral interface bus or another suitable communications link. Communication includes exchanging data signals in suitable form, including, for example, electrical signals via a conductive medium, electromagnetic signals via air, optical signals via optical waveguides, and the like. Data signals may include signals representing inputs from sensors, signals representing actuator commands, and communications signals between controllers.

The wireless communication technology 25 may include a telematics device, which includes a wireless telematics communication system capable of extra-vehicle communications, including communicating with a communication network system having wireless and wired communication capabilities. The telematics device facilitates and enables short-range wireless communication to the handheld console 100. Furthermore, the telematics device may be capable of extra-vehicle communications that includes short-range ad hoc vehicle-to-vehicle (V2V) communication and/or vehicle-to-everything (V2x) communication, which may include communication with an infrastructure monitor, e.g., a traffic camera and ad hoc vehicle communication.

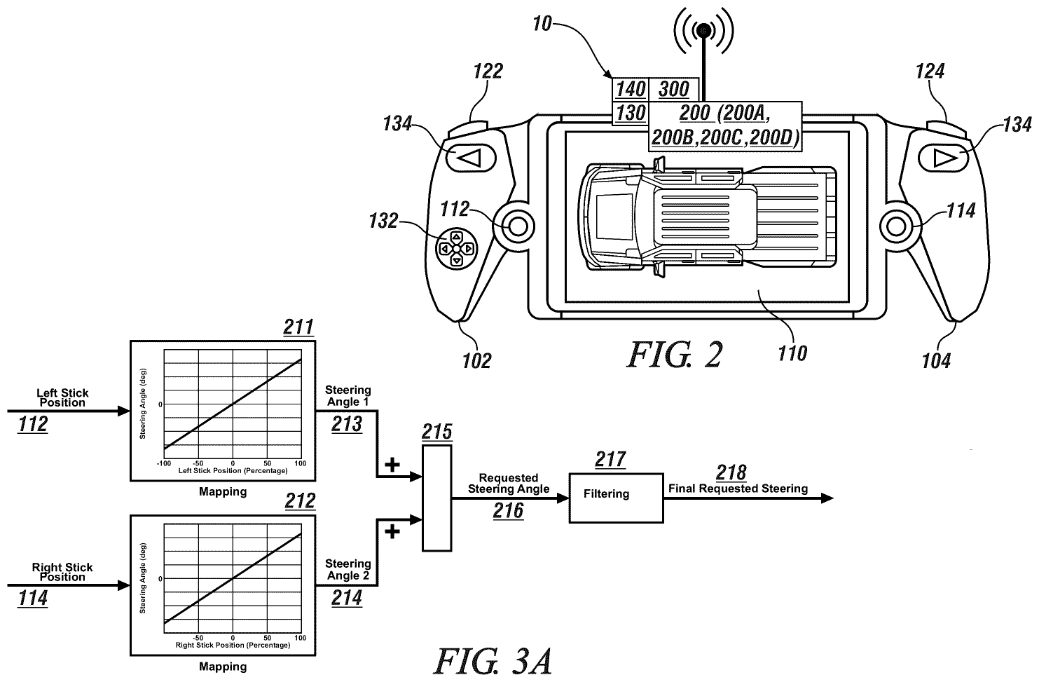

Referring now to FIG. 2, with continued reference to elements of the vehicle 10 that are described with reference to FIG. 1, details related to the handheld console 100 are described, wherein the handheld console 100 may be employed to remotely control one or more of the steering subsystem 30 via steering controller 35, the wheel braking subsystem 40 via braking controller 45, the propulsion subsystem 50 via propulsion controller 55, including using information from the spatial monitoring subsystem 60 and the navigation subsystem 65.

The handheld console 100 includes first and second grip portions 102, 104, respectively, first and second analog sticks 112, 114, respectively, first and second analog triggers 122, 124, respectively, selector switch 132, bi-stable switch 134, display screen 110, and a communication link 140. The first and second analog sticks 112, 114, respectively, first and second analog triggers 122, 124, respectively, selector switch 132, bi-stable switch 134, display screen 110, and communication link 140 are in communication with a console controller 130, which may be arranged in the handheld console 100 in one embodiment. Alternatively, the console controller 130 may be arranged on-vehicle. The communication link 140 may include either or both a wired communication link via a cable and/or a wireless communication link. The console controller 130 may be in communication with the VR headset 105 in one embodiment. The console controller 130 includes, in one embodiment, one or multiple steering control routine(s) 200 and a longitudinal acceleration control routine 300. It is appreciated that some of the functions described herein as being performed in the console controller 130 may be executed and/or performed in the vehicle controller 20, or another controller.

Other non-limiting embodiments of interactive devices or mechanisms that may be employed as the first and second analog sticks 112, 114, and/or the first and second analog triggers 122, 124 include joysticks, slidable knobs, triggers, buttons, bumper buttons, hat switches, wheels, D-pads, and so forth, without limitation.

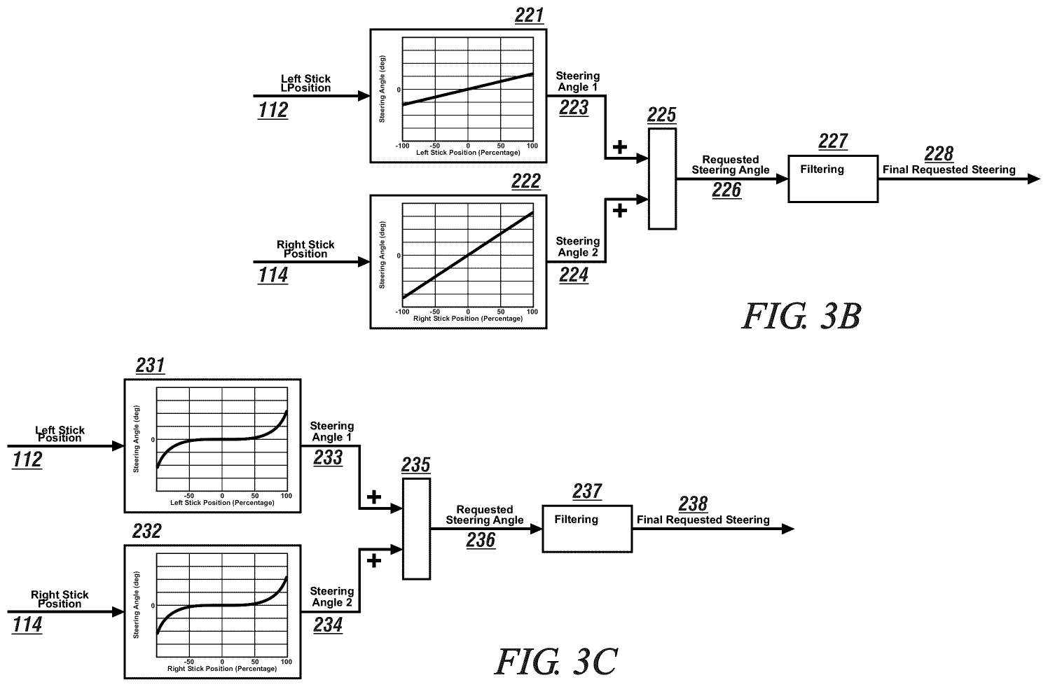

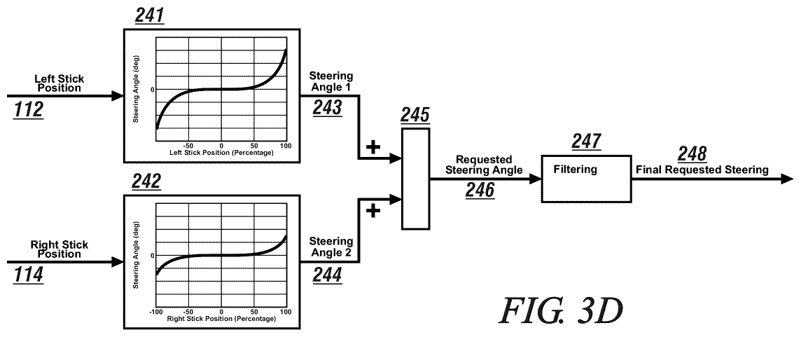

Different embodiments of the steering control routine 200, indicated as elements 200A, 200B, 200C, and 200D, are described with reference to FIGS. 3A, 3B, 3C, and 3D, respectively. The different embodiments of the steering control routine 200, indicated as elements 200A, 200B, 200C, and 200D, may be operator-selectable employing the selector switch 132.

Direction of travel, in the form of forward or reverse, may be operator-selectable employing the bi-stable switch elements 134.

As described herein, the handheld console 100 may be employed by the operator 101 to control operation of the vehicle 10.

In one embodiment, the first and second analog sticks 112, 114 may be employed to remotely control the steering subsystem 30 via steering controller 35, thus distributing the input across twice the range, which enhances precision without sacrificing overall range, and limiting full range of one of the sticks to prevent accidental over-aggressive steering. In one embodiment, this includes the first analog stick 112 having a range of authority from −100% to +100% as it traverses from a left-full stop position to a right-full stop position, and the second analog stick 114 having a range of authority from −100% to +100% as it traverses from a left-full stop position to a right-full stop position. In one embodiment, the first (e.g., left) analog stick 112 is mapped to half of the steering range, and the second (e.g., right) analog stick 114 is mapped to half of the steering range, with the final steering command being a combination of left stick and right stick mapping.

FIG. 3A schematically illustrates a first embodiment of the steering control routine 200A for controlling vehicle steering employing the console 100.

In this embodiment, a first steering calibration map 211 provides a linear relationship between a position input (%) from the first (e.g., left) analog stick 112 (depicted on the horizontal axis), and a steering angle command (degrees). The position input (%) has a range of authority from −100% to +100% that corresponds to a range of the first analog stick 112 between a left-full stop position and a right-full stop position, which corresponds to a steering angle command between a maximum or calibratable leftward steering angle and a maximum or calibratable rightward steering angle, respectively.

In this embodiment, a second steering calibration map 212 provides a linear relationship between a position input (%) from the second (e.g., right) analog stick 114 (depicted on the horizontal axis), and a steering angle command (degrees). The position input (%) has a range of authority from −100% to +100% that corresponds to a range of the second analog stick 114 between a left-full stop position and a right-full stop position, which also corresponds to a steering angle command between a maximum or calibratable leftward steering angle and a maximum or calibratable rightward steering angle, respectively.

As such, in this embodiment, the first steering calibration map 211 has the same or equivalent authority as the second steering calibration map 212, i.e., the change in steering angle in relation to a change in position input from the corresponding first or second analog sticks 112, 114 is the same.

In execution, the first embodiment of the steering control routine 200A operates as follows. A first input in the form of the position of the first analog stick 112 is dynamically monitored to determine a first steering angle 213 based upon the first steering calibration map 211, and a second input in the form of the position of the second analog stick 114 is coincidently dynamically monitored to determine a second steering angle 214 based upon the second steering calibration map 212. The first steering angle 213 and the second steering angle 214 are combined by a summing step 215 to determine a requested steering angle 216, which is subjected to a filter step 217 to determine a final steering angle command 218, which is communicated to the steering controller 35 to remotely control the steering subsystem 30.

FIG. 3B schematically illustrates another embodiment of the steering control routine 200B for controlling vehicle steering employing the console 100.

In this embodiment, a first steering calibration map 221 provides a linear relationship between a position input (%) from the first (e.g., left) analog stick 112 (depicted on the horizontal axis), and a steering angle command (degrees). The position input (%) from the first analog stick 112 has a range of authority from −100% to +100% that corresponds to a range of the first analog stick 112 between a left-full stop position and a right-full stop position, which also corresponds to a steering angle command between a partial leftward steering angle and a partial rightward steering angle, respectively. The partial leftward steering angle and the partial rightward steering angle are calibratable values that are less than 100%, and may be application-specific.

In this embodiment, a second steering calibration map 222 provides a linear relationship between a position input (%) from the second (e.g., right) analog stick 114 (depicted on the horizontal axis), and a steering angle command (degrees). The position input (%) has a range of authority from −100% to +100% that corresponds to a range of the second analog stick 114 between a left-full stop position and a right-full stop position, which also corresponds to a steering angle command between a maximum or calibratable leftward steering angle and a maximum or calibratable rightward steering angle, respectively.

As such, in this embodiment, the first steering calibration map 221 provides a fine range of authority, i.e., a relatively small change in steering angle in relation to a change in position input from the first analog stick 112, and the second steering calibration map 222 provides a coarse range of authority, i.e., a relatively large change in steering angle in relation to a change in position input from the second analog stick 114.

In execution, the steering control routine 200B operates as follows. A first input in the form of the position of the first analog stick 112 is dynamically monitored to determine a first steering angle 223 based upon the first steering calibration map 221, and a second input in the form of the position of the second analog stick 114 is coincidently dynamically monitored to determine a second steering angle 224 based upon the second steering calibration map 222. The first steering angle 223 and the second steering angle 224 are combined by a summing step 225 to determine a requested steering angle 226, which is subjected to a filtered/rate-limited step 227 to determine a final steering angle command 228, which is communicated to the steering controller 35 to remotely control the steering subsystem 30. The filtered/rate-limited step 227 operates to remove signal noise and provide a speed-based limit on the rate of change in the final steering angle command 228.

FIG. 3C schematically illustrates another embodiment of the steering control routine 200C for controlling vehicle steering employing the console 100.

In this embodiment, a first steering calibration map 231 provides a non-linear relationship between a position input (%) from the first (e.g., left) analog stick 112 (depicted on the horizontal axis), and a steering angle command (degrees). The position input (%) from the first analog stick 112 has a range of authority from −100% to +100% that corresponds to a range of the first analog stick 112 between a left-full stop position and a right-full stop position, which also corresponds to a steering angle command between a maximum or calibratable leftward steering angle and a maximum or calibratable rightward steering angle, respectively.

In this embodiment, a second steering calibration map 232 provides a non-linear relationship between a position input (%) from the second (e.g., right) analog stick 114 (depicted on the horizontal axis), and a steering angle command (degrees). The position input (%) has a range of authority from −100% to +100% that corresponds to a range of the second analog stick 114 between a left-full stop position and a right-full stop position,, which also corresponds to a steering angle command between a maximum or calibratable leftward steering angle and a maximum or calibratable rightward steering angle, respectively.

As such, in this embodiment, the first steering calibration map 231 provides the same range of authority as the second steering calibration map 232.

In execution, the steering control routine 200C operates as follows. A first input in the form of the position of the first analog stick 112 is dynamically monitored to determine a first steering angle 233 based upon the first steering calibration map 231, and a second input in the form of the position of the second analog stick 114 is coincidently dynamically monitored to determine a second steering angle 234 based upon the second steering calibration map 232. The first steering angle 233 and the second steering angle 234 are combined by a summing step 235 to determine a requested steering angle 236, which is subjected to a filter step 237 to determine a final steering angle command 238, which is communicated to the steering controller 35 to remotely control the steering subsystem 30.

FIG. 3D schematically illustrates another embodiment of the steering control routine 200D for controlling vehicle steering employing the console 100.

In this embodiment, a first steering calibration map 241 provides a non-linear relationship between a position input (%) from the first (e.g., left) analog stick 112 (depicted on the horizontal axis), and a steering angle command (degrees). The position input (%) from the first analog stick 112 has a range of authority from −100% to +100% that corresponds to a range of the first analog stick 112 between a left-full stop position and a right-full stop position, which also corresponds to a steering angle command between a partial leftward steering angle and a partial rightward steering angle, respectively.

In this embodiment, a second steering calibration map 242 provides a non-linear relationship between a position input (%) from the second (e.g., right) analog stick 114 (depicted on the horizontal axis), and a steering angle command (degrees). The position input (%) has a range of authority from −100% to +100% that corresponds to a range of the second analog stick 114 between a left-full stop position and a right-full stop position, which also corresponds to a steering angle command between a maximum or calibratable leftward steering angle and a maximum or calibratable rightward steering angle, respectively.

As such, in this embodiment, the first steering calibration map 241 provides a fine range of authority, i.e., a relatively small change in steering angle in relation to a change in position input from the first analogous stick 112, and the second steering calibration map 242 provides a coarse range of authority, i.e., a relatively large change in steering angle in relation to a change in position input from the second analog stick 114.

In execution, the steering control routine 200D operates as follows. A first input in the form of the position of the first analog stick 112 is dynamically monitored to determine a first steering angle 243 based upon the first steering calibration map 241, and a second input in the form of the position of the second analog stick 114 is coincidently dynamically monitored to determine a second steering angle 244 based upon the second steering calibration map 242. The first steering angle 243 and the second steering angle 244 are combined by a summing step 245 to determine a requested steering angle 246, which is subjected to a filtered/rate-limited step 247 to determine a final steering angle command 248, which is communicated to the steering controller 35 to remotely control the steering subsystem 30. The filtered/rate-limited step 247 operates to remove signal noise and provide a speed-based limit on the rate of change in the final steering angle command 248.

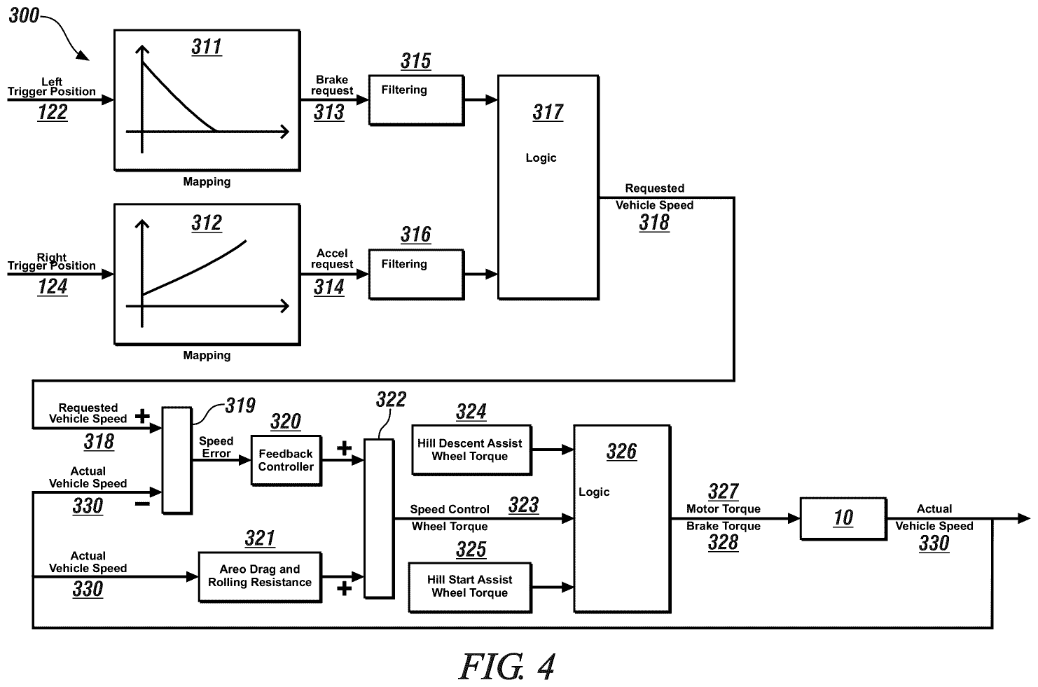

FIG. 4 schematically illustrates another embodiment of the longitudinal acceleration control routine 300 for controlling vehicle acceleration and braking employing the first and second analog triggers 122, 124, respectively, of the console 100 that is described with reference to FIG. 2. In one embodiment, and as illustrated, the first (left) analog trigger 122 provides a vehicle braking control function, and the second (right) analog trigger 124 provides a vehicle longitudinal acceleration function that may be adapted for road or other travel surface situations having slopes, berms, narrow roads, and indoor navigation.

In this embodiment, a braking calibration map 311 provides a non-linear relationship between a position input (%) from the first (e.g., left) analog trigger 122 (depicted on the horizontal axis), and a desired vehicle speed (m/s). The position input (%) from the first analog trigger 122 has a range of authority that corresponds to a range of the first analog trigger 122 between a fully open position and a fully depressed position, which also corresponds to braking command that falls between no braking and a maximum braking/zero speed command, respectively. A first desired vehicle speed 313 associated with a braking request may be determined based upon the position input (%) from the first analog trigger 122.

Alternatively, the braking calibration map may provide a linear relationship between the position input (%) from the first (e.g., left) analog trigger 122 and a desired vehicle speed (m/s).

In this embodiment, vehicle longitudinal acceleration calibration map 312 provides a non-linear relationship between a position input (%) from the second (e.g., right) analog trigger 124 (depicted on the horizontal axis), and a desired vehicle speed (m/s). The position input (%) from the second analog trigger 124 has a range of authority that corresponds to a range of the second analog trigger 124 between a fully open position and a fully depressed position, which also corresponds to a longitudinal acceleration command between no acceleration and a maximum acceleration command, respectively. A second desired vehicle speed 314 associated with a longitudinal acceleration request may be determined based upon the position input (%) from the second analog trigger 124.

Alternatively, the vehicle longitudinal acceleration calibration map may provide a linear relationship between a position input (%) from the second (e.g., right) analog trigger, and a desired vehicle speed (m/s).

The first desired vehicle speed 313 associated with the braking request that is input from the first analog trigger 122 is subjected to a first filtering function 315, and the second desired vehicle speed 314 associated with the longitudinal acceleration request that is input from the second analog trigger 124 is subjected to a second filtering function 316, and resultants are subjected to a logic analysis 317, such as arbitration, to determine a requested vehicle speed 318.

The requested vehicle speed 318 and actual vehicle speed 330 are employed to determine magnitude(s) of motor torque 327 and/or braking torque 328 that are necessary to control the propulsion subsystem 50 via the propulsion controller 55, and/or control the wheel braking subsystem 40 via the braking controller 45 of the vehicle 10 to achieve the requested vehicle speed 330.

A difference function 319 determines a speed error, i.e., a difference between the requested vehicle speed 318 and actual vehicle speed 330, which is input to a feedback controller 320. A change in speed based upon aerodynamic drag and rolling resistance 321 is also determined, and such effects are combined to determine a speed control-based desired wheel torque 323. A hill descent wheel torque 324 (if any) and a hill start wheel torque 325 (if any), are subjected to a logic analysis 326 in conjunction with the speed control-based desired wheel torque 323 to determine the magnitude(s) of motor torque 327 and/or braking torque 328 that are necessary to control the propulsion subsystem 50 via the propulsion controller 55, and/or control the wheel braking subsystem 40 via the braking controller 45 of the vehicle 10 to achieve the requested vehicle speed 330.

Default operation describes an operating state in which the respective trigger is not pressed. The default state for the first and second analog sticks 112, 114 is zero steering input. The default state for the first and second analog triggers 122, 124 is a low speed operation, e.g., an operating speed of 0.5 m/s, in one embodiment.

As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium. The term ‘model’ refers to a processor-based or processor-executable code and associated calibration that simulates a physical existence of a device or a physical process. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. The terms “calibration”, “calibrated”, and related terms refer to an input/output relationship in which a measured or observed input parameter is mapped to or correlated to a desired output parameter. A calibration as described herein can be reduced to a storable parametric table, a plurality of executable equations or another suitable form that may be employed as part of a measurement or control routine. A parameter is defined as a measurable quantity that represents a physical property of a device or other element that is discernible using one or more sensors and/or a physical model. A parameter can have a discrete value, e.g., either “1” or “0”, or can be infinitely variable in value.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that can direct a computer or other programmable data processing apparatus to function in a particular manner, such that the instructions stored in the computer-readable medium produce an article of manufacture including instruction set that implements the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A control system for a vehicle, the control system comprising:
a handheld console, a first controller, and a first subsystem controller;
the handheld console including first and second grip portions, first and second analog sticks, and a communication system;
the first and second analog sticks in communication with the first controller;
the first subsystem controller operatively connected to an on-vehicle steering system;
the first controller arranged to communicate with the first subsystem controller of the vehicle via the communication system; and
the first controller including a first control routine, a first steering calibration map, and a second steering calibration map;
the first control routine including algorithmic code that is executable to:
monitor a first input from the first analog stick, and determine a first steering angle based upon the first input and the first steering calibration map,
monitor a second input from the second analog stick, and determine a second steering angle based upon the second input and the second steering calibration map,
determine a final steering angle command based upon the first steering angle and the second steering angle,
communicate, via the communication system, the final steering angle command to the first subsystem controller of the vehicle, and
control, via the first subsystem controller, the steering system in response to the final steering angle command.

2. The control system of claim 1, wherein the first steering calibration map comprises a first linear relationship between the first input from the first analog stick and the first steering angle;
wherein the second steering calibration map comprises a second linear relationship between the second input from the second analog stick and the second steering angle; and
wherein the first linear relationship is equivalent to the second linear relationship.

3. The control system of claim 1, wherein the first steering calibration map comprises a first linear relationship between the first input from the first analog stick and the first steering angle;
wherein the second steering calibration map comprises a second linear relationship between the second input from the second analog stick and the second steering angle; and
wherein the first linear relationship provides a coarse steering angle response, and wherein the second linear relationship provides a fine steering angle response.

4. The control system of claim 1, wherein the first steering calibration map comprises a first non-linear relationship between the first input from the first analog stick and the first steering angle;
wherein the second steering calibration map comprises a second non-linear relationship between the second input from the second analog stick and the second steering angle; and
wherein the first non-linear relationship is equivalent to the second non-linear relationship.

5. The control system of claim 1, wherein the first steering calibration map comprises a first non-linear relationship between the first input from the first analog stick and the first steering angle;
wherein the second steering calibration map comprises a second non-linear relationship between the second input from the second analog stick and the second steering angle; and
wherein the first non-linear relationship provides a coarse steering angle response, and wherein the second non-linear relationship provides a fine steering angle response.

6. The control system of claim 1, further comprising the handheld console including a first selector switch having a first state and a second state;
wherein, when the first selector switch is in the first state, the first steering calibration map is equivalent to the second steering calibration map; and
wherein, when the first selector switch is in the second state, the first steering calibration map differs from the second steering calibration map.

7. The control system of claim 1, wherein a first default input from the first analog stick comprises a zero steering command, and wherein a second default input from the second analog stick comprises a zero steering command.

8. The control system of claim 1, further comprising:
the handheld console including a first analog trigger and a second analog trigger, the first analog trigger and the second analog trigger being in communication with the first controller;
a second subsystem controller operatively connected to an on-vehicle braking system;
a third subsystem controller operatively connected to an on-vehicle propulsion system; and
the first controller including a second control routine, a braking calibration map, and an acceleration calibration map;
the second control routine including algorithmic code that is executable to:
monitor, via the first analog trigger, a third input; and determine a braking request based upon the third input and the braking calibration map,
monitor, via the second analog trigger, a fourth input, and determine an acceleration request based upon the fourth input and the acceleration calibration map,
determine a vehicle speed request based upon the braking request and the acceleration request,
communicate, via the communication system, the vehicle speed request to the second subsystem controller and the third subsystem controller of the vehicle, and
control, via the second and third subsystem controllers, the braking system and the propulsion system in response to the vehicle speed request.

9. The control system of claim 8, wherein a second default input from the first analog trigger comprises a non-zero braking command.

10. The control system of claim 8, wherein a third default input from the second analog trigger comprises a non-zero acceleration command.

11. The control system of claim 8, further comprising:
the handheld console including a first switch having a first position and a second position; and
a fourth subsystem controller operatively connected to a transmission range selector, the transmission range selector operative to control the vehicle in one of a forward direction or a reverse direction;
wherein the fourth subsystem controller is operative to command the transmission range selector to operate the vehicle in the forward direction when the first switch is in the first position; and
wherein the fourth subsystem controller is operative to command the transmission range selector to operate the vehicle in the reverse direction when the first switch is in the second position.

12. The control system of claim 1, further comprising the handheld console including a digital display screen arranged to display a representation of the vehicle in situ.

13. The control system of claim 1, further comprising a virtual reality headset arranged to display a representation of the vehicle in situ.

14. A control system for a vehicle, the control system comprising:
a handheld console, a steering controller, a braking controller, and a propulsion controller;
the handheld console including first and second analog sticks, first and second analog triggers, a first controller, and a communication system;
the first and second analog sticks in communication with the first controller;
the first and second analog triggers in communication with the first controller;
the first controller arranged to communicate with the steering controller, the braking controller and the propulsion controller via the communication system; and
the first controller including a first control routine, a first steering calibration map, and a second steering calibration map;
the first control routine including algorithmic code that is executable to monitor a first input from the first analog stick, monitor a second input from the second analog stick, and control a vehicle steering system via the steering controller based thereon;
the first controller including a second control routine, a braking calibration map, and a longitudinal acceleration calibration map; and
the second control routine including algorithmic code that is executable to monitor an input from the first analog trigger, monitor an input from the second analog trigger, and control vehicle braking via the braking controller and vehicle acceleration via the propulsion controller based thereon.

15. The control system of claim 14, further comprising the handheld console including a digital display screen arranged to display a representation of the vehicle in situ.

16. The control system of claim 14, further comprising a virtual reality headset arranged to display a representation of the vehicle in situ.

17. The control system of claim 14, further comprising:
the handheld console including a first bi-stable switch having a first position and a second position; and
a fourth subsystem controller operatively connected to a transmission range selector, the transmission range selector operative to control the vehicle in one of a forward direction or a reverse direction;
wherein the fourth subsystem controller is operative to command the transmission range selector to operate the vehicle in the forward direction when the first bi-stable switch is in the first position; and
wherein the fourth subsystem controller is operative to command the transmission range selector to operate the vehicle in the reverse direction when the first bi-stable switch is in the second position.

18. A method for controlling a vehicle, the method comprising:
arranging a handheld console including first and second analog sticks;
monitoring, via a controller, a first input from the first analog stick;
determining, via a first steering calibration map, a first steering angle based upon the first input;
monitoring, via the controller, a second input from the second analog stick;
determining, via a second steering calibration map, a second steering angle based upon the second input;
determining a final steering angle command based upon the first steering angle and the second steering angle;
communicating, via a communication system, the final steering angle command to a first subsystem controller of the vehicle; and
controlling, via the first subsystem controller, a steering system of the vehicle in response to the final steering angle command.

19. The method of claim 18, further comprising;
arranging the console including a first analog trigger and a second analog trigger,
monitoring, via the first analog trigger, a third input;
determining, via a braking calibration map, a braking request based upon the third input;
monitoring, via the second analog trigger, a fourth input;
determining, via an acceleration calibration map, an acceleration request based upon the fourth input;
determining a vehicle speed request based upon the braking request and the acceleration request;
communicating, via the communication system, the vehicle speed request to a second subsystem controller and a third subsystem controller of the vehicle; and
controlling, via the second and third subsystem controllers, a braking system and a propulsion system in response to the vehicle speed request.

20. The method of claim 18, further comprising: displaying, via a virtual reality headset, a representation of the vehicle in situ.
